(19) United States
(12) Patent Application Publication
(10) Pub. No.: US 2010/0034314 A1
(43) Pub. Date: Feb. 11, 2010

(54) Antenna Configuration and Transmission Mode Signaling In Wireless Communication System

(75) Inventors: Tyler A Brown, Mundelein, IL (US); Michael E. Buckley, Grayslake, IL (US); Ravikiran Nory, Palatine, IL (US); Kenneth A. Stewart, Grayslake, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 12/189,766

(22) Filed: Aug. 11, 2008

(51) Int. Cl. H04L 27/00

(52) U.S. Cl. 375/295

(57) ABSTRACT

A wireless communication infrastructure entity including a transceiver communicably coupled to a controller configured to generate a handover message having a multi-bit field, the controller configured to set a value of the multi-bit field, the value of the multi-bit field jointly encoded to indicate both a transmission mode to be used after handover and an antenna configuration of a target

### FIELD OF THE DISCLOSURE

The present disclosure relates generally to wireless communications and more particularly to antenna configuration and transmission mode, for use after handover, signaling in wireless communication systems.

### BACKGROUND

In the developing 3GPP Long Term Evolution (LTE) of Universal Mobile Telecommunications Systems (UMTS), user equipment (UE) receiving downlink data on the PDSCH may, as presently specified, operate in one of a set of transmission modes. A transmission mode is a description of one out of a set of rules governing the transmission of information between two entities. The following 7 transmission modes are currently defined in 3GPP LTE: (1) single-antenna port, port 0; (2) transmit diversity; (3) open-loop spatial multiplexing; (4) closed-loop spatial multiplexing; (5) multi-user MIMO; (6) closed-loop Rank=1 preceding; and (7) single-antenna port, port 5. These transmission modes to be used after handovers, are semi-statically configured, and are UE-specific.

Related to the transmission mode is the antenna configuration of a cell which is defined as the number of common RS-bearing antenna ports. The antenna configuration is a property of the cell and is therefore cell-specific. The user equipment (UE) may determine the antenna configuration of a particular cell by cell's broadcast channel (BCH, or more precisely, the Physical Broadcast Channel or PBCH) transmission upon first accessing the system. The antenna configuration is not explicitly contained in the message transmitted on the BCH but is rather transported via a mask which is used to scramble the CRC of this message. The user-specific transmission mode and the cell-specific antenna configuration are related in that not all transmission modes can be used in all antenna configurations. For example, transmission modes 2 through 6 are not permitted for an antenna configuration with a single common-RS bearing antenna port configuration.

When a UE is handed over to a new cell, the UE must be informed of the antenna configuration of the new cell in order to decode the control channel. In addition, the UE must be assigned a transmission mode supported by the new cell in order to receive transmissions from the cell on the data channel (Physical Downlink Shared Channel or PDSCH) after handover. It is necessary that the transmission mode to be used after handover be supported by both the cell and the UE. For example, transmission mode number 7, single-antenna port 5 transmission is optional for a UE configured using the frequency division duplexing (FDD) method and thus may not be supported by all UE's. While it is possible for the UE to read the BCH of the new cell after some event such as a handover event to determine its antenna configuration, the delay involved in receiving and decoding this message increases transmission interruption time and renders this solution less than optimal. Instead, the 3GPP committees (RAN1 and RAN2) that produce the physical layer and MAC layer specifications has proposed that the antenna configuration of the cell should be signaled in a handover message. In 3GPP TSG-RAN WG2 #62bis, T-doc R2-083668, Ericsson has further proposed to separately encode antenna configuration and transmission information in the handover message. It is also desirable to minimize the number of bits in the handover message since this message must reach the cell boundaries where handovers typically occur.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system.

FIG. 2 illustrates a schematic wireless communication infrastructure entity block diagram.

FIG. 3 illustrates a schematic wireless communication user terminal block diagram.

FIG. 4 is a table mapping bit field values to transmission mode and antenna configuration.

FIG. 5 is another table mapping bit field values to transmission mode and antenna configuration.

FIG. 6 is a yet another table mapping bit field values to transmission mode and antenna configuration.

### DETAILED DESCRIPTION

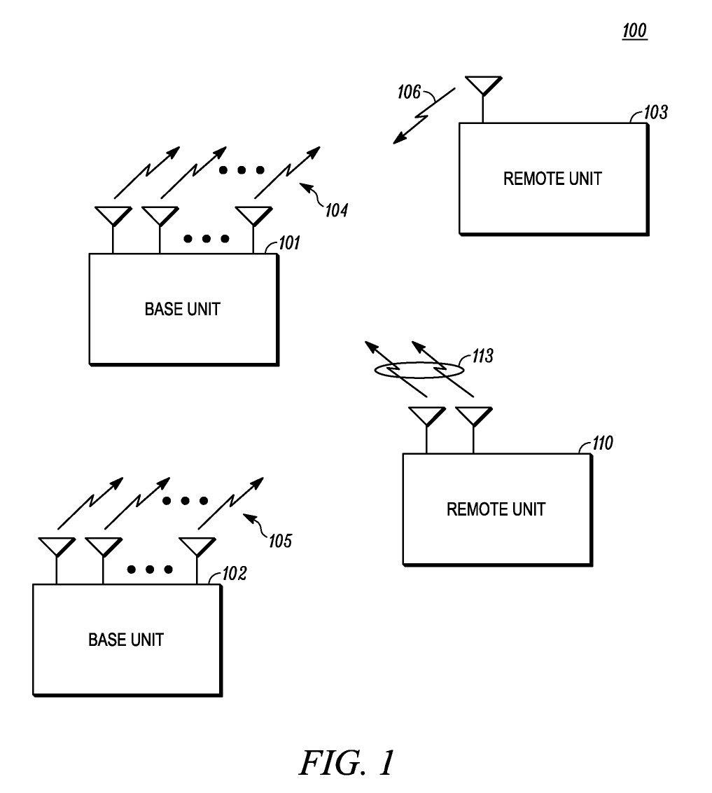

In FIG. 1, a wireless communication system 100 comprises one or more fixed base infrastructure units forming a network distributed over a geographical region. The base unit may also be referred to as an access point, access terminal, base, base station, Node-B, eNode-B, eNB or by other terminology used in the art. In FIG. 1, the one or more base units 101 and 102 serve a number of remote units 103 and 110 within a serving area, for example, a cell or a cell sector. The remote units may be fixed units or mobile terminals. The remote units may also be referred to as subscriber units, mobiles, mobile stations, users, terminals, subscriber stations, user equipment (UE), terminals, or by other terminology used in the art.

Generally, the base units 101 and 102 transmit downlink communication signals 104 and 105 to serve remote units in the time and/or frequency domain. The remote units 103 and 110 communicate with the one or more base units via uplink communication signals 106 and 113. The one or more base units may comprise one or more transmitters and one or more receivers for downlink and uplink transmissions. The remote units may also comprise one or more transmitters and one or more receivers. The base units are generally part of a radio access network that includes one or more controllers communicably coupled to one or more corresponding base units. The access network is generally communicably coupled to one or more core networks, which may be coupled to other networks, like the Internet and public switched telephone networks, among others. These and other elements of the access and core networks are not illustrated but they are known by those having ordinary skill in the art.

In one implementation, the wireless communication system is compliant with the developing Long Term Evolution (LTE) mode of the 3GPP Universal Mobile Telecommunications System (UMTS) protocol, also referred to as EUTRA, wherein the base station transmits using an orthogonal frequency division multiplexing (OFDM) modulation scheme on the downlink and the user terminals transmit on the uplink using a single carrier frequency division multiple access (SC-FDMA) scheme. More generally, however, the wireless communication system may implement some other open or proprietary communication protocol, for example, WiMAX, among other protocols. The present disclosure is not intended to be limited to the implementation of any particular wireless communication system architecture or protocol.

In some wireless communication systems, when a UE is handed over from one cell (the origination cell) to another (the target cell), the UE must be informed of the antenna configuration of the target or destination cell. The transmission mode is specific to a link between a wireless communication infrastructure entity, e.g., a base station, and a user terminal. The transmission mode may also change within a cell, for example, within the serving cell without the requirement of a handover. In 3GPP, for example, the Long Term Evolution (LTE) of Universal Mobile Telecommunications Systems (UMTS) is expected to permit up to 4 antenna ports to be defined for multi-antenna base station transmissions and permits using 1, 2 or 4 antenna ports for selected physical channel transmissions, although future evolutions of LTE envisage antenna configurations with a larger number of antenna ports. The Physical Broadcast Channel (PBCH) may be transmitted using all three of these latter antenna port configurations. Generally, not all base stations will be equipped with the same number of antennas, and so the multiple base stations that constitute a wireless communication system may potentially have different antenna configurations. Also, in some system implementations, the antenna configuration of the one or more base terminals is changed dynamically.

In some wireless communication systems, when a UE is handed over from the origination cell to the target cell, the UE must also be informed of the transmission mode by the network when operating in the target cell or assigned a transmission mode on arrival. For example, in 3GPP LTE, the UE receiving downlink data on the PDSCH may operate in one of the 7 following transmission modes: (1) single-antenna port, port 0; (2) transmit diversity; (3) open-loop spatial multiplexing; (4) closed-loop spatial multiplexing; (5) multi-user MIMO; (6) closed-loop rank=1 precoding; and (7) single-antenna port, port 5. These modes are semi-statically configured—i.e. infrequently updated—and are UE-specific. However, not all UE's can operate in all transmission modes. In 3GPP LTE, for example, mode number 7, single-antenna port 5 transmission, is optional for a UE using the FDD duplex method and thus may not be supported by all UE's. Moreover, the transmission mode and the configuration are related in that not all transmission modes can be used in all antenna configurations. For example, modes 2 through 6 are not permitted for an antenna configuration with a single common-RS bearing antenna port. The antenna configuration is specific to the wireless communication infrastructure entity.

In 3GPP LTE, the UE is assigned a transmission mode for use in the target cell in order for the UE to receive transmissions from the target cell, for example, on the target cell PDSCH, after handover. The UE may also be assigned a different transmission mode in the current cell, without handing over. More generally, user terminals operating pursuant to other wireless communication protocols may also operate in different transmission modes, and thus it may also be desirable to assign a transmission mode to the UE in other wireless communication systems.

According to another aspect of the disclosure, the antenna configuration and the transmission mode assignment information for a UE are communicated in a common message, for example, in a handover message. In other implementations however this information may be communicated in some other message. In order to accrue the benefit of minimizing the total number of bits comprising the bit field, the transmission mode and antenna configuration are not identified in separate portions of the same bit field or in separate bit fields. The value of a multi-bit field is jointly encoded over transmission mode and antenna configuration information. By jointly encoding the transmission mode and antenna configuration information, every bit state in the value of the multi-bit field depends on both the transmission mode and on the antenna configuration.

As suggested above, the antenna configuration and the transmission mode assignment may be required when a UE hands over from serving cell to a target cell or when the UE is assigned a new transmission mode within the serving cell. For the non-handover case, the transmission mode is specific to a link between the serving wireless communication infrastructure entity and the user terminal, and the antenna configuration is specific to the wireless communication infrastructure entity that generates the message. The serving base station will likely have generated the message containing the jointly encoded transmission mode and antenna configuration. For the handover case, the transmission mode is specific to a link between a target wireless communication infrastructure entity and the user terminal after handover and the antenna configuration is specific to the target wireless communication infrastructure entity after handover wherein the message is most likely a handover message.

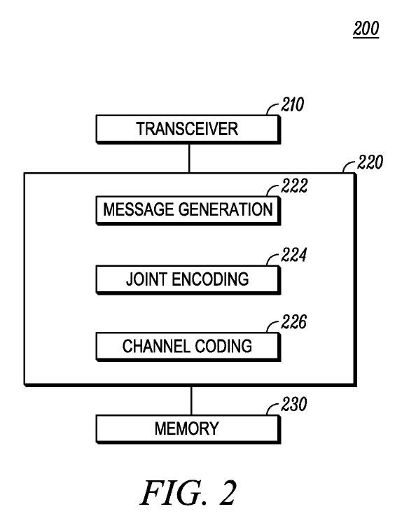

In FIG. 2, a wireless communication infrastructure entity 200 comprises a transceiver 210 communicably coupled to a controller 220. In one embodiment, the wireless communication infrastructure entity corresponds to one of the base units of FIG. 1. The transceiver generally communicates with one or more user terminals within its coverage area. In FIG. 2, the controller is most readily implemented as a digital processor controlled by software and/or firmware stored in memory 230. Alternatively, however the controller may be implemented as a hardware equivalent device or as a combination of hardware and software.

In FIG. 2, the controller includes message generation functionality 222 used to generate messages for transmission to UE within a service area of the base station. In one embodiment, the controller generates a handover message for transmission to a UE handing over from one base station to another to base station or from one sector within a cell served by a base station to another sector within the same cell. More generally, the message could be any communication transmitted in a broadcast or in a point-to-point communication. Thus under software and/or firmware control, the controller is configured to generate messages for transmission to a UE within the service area of the base station. The message, for example, a handover message, has a multi-bit information field for transmitting information to the UE.

In one embodiment where the message generated is a handover message, the controller is configured to encode a multi-bit information field of the handover message to indicate both a transmission mode to be used after handover and an antenna configuration of a target cell. In FIG. 2, the controller includes joint encoding functionality 224 for this purpose. In one implementation, the handover message is a two-bit field. The controller also includes channel coding functionality 226 used to channel code the handover message transmission.

In one embodiment, the controller is configured to set the value of the multi-bit field to indicate that the transmission mode to be used after handover and the antenna configuration of the target wireless communication infrastructure entity are the same as a transmission mode and an antenna configuration of a source wireless communication infrastructure entity. In another embodiment, the controller is configured to set the value of the multi-bit field to indicate a default transmission mode and a default antenna configuration. Alternatively, the controller is configured to set the value of the multi-bit field to indicate a default transmission mode and any antenna configuration. In one implementation, the default transmission mode is diversity transmission mode.

In one embodiment, a first value of the multi-bit field is encoded to indicate that the transmission mode to be used after handover and the antenna configuration of the target cell are the same as a transmission mode used in the source cell and an antenna configuration of a source cell. A second value of the multi-bit field is encoded to indicate that the transmission mode to be used after handover is a default transmission mode and that the antenna configuration is for 1 cell-specific antenna port. A third value of the multi-bit field is encoded to indicate that the transmission mode to be used after handover is a default transmission mode and that the antenna configuration is for 2 cell-specific antenna ports. A fourth value of the multi-bit field is encoded to indicate that the transmission mode to be used after handover is a default transmission mode and that the antenna configuration is for 4 cell-specific antenna ports. In one implementation, the default transmission mode is diversity transmission mode.

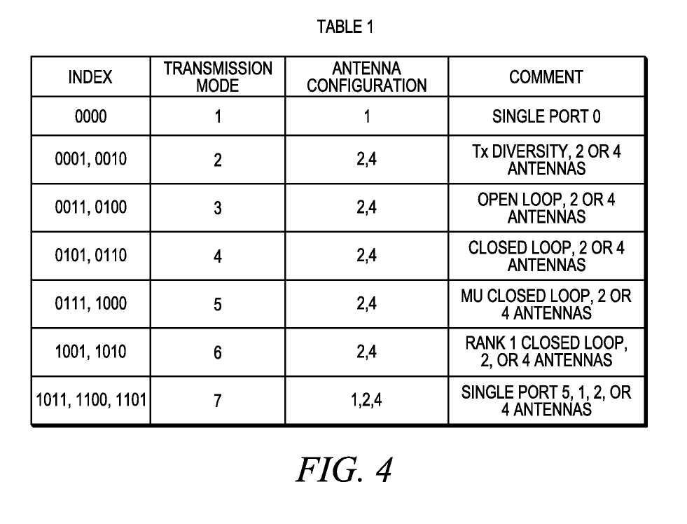

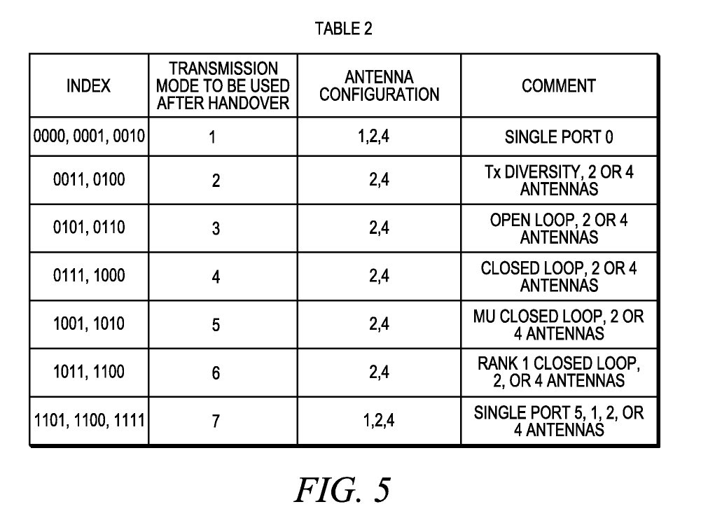

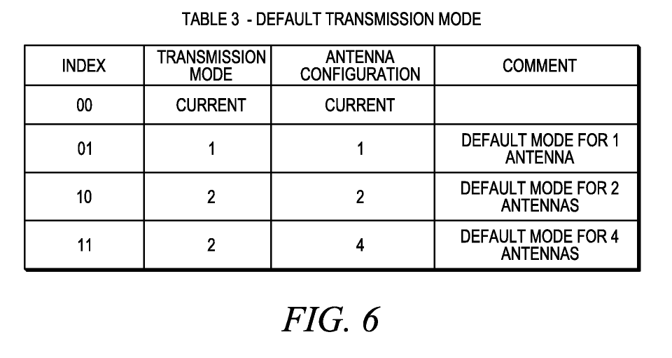

In an exemplary 3GPP LTE implementation, only four bits are required to put the UE into any transmission mode for any cell antenna configuration. An exemplary four bit implementation is shown in the Table 1 of FIG. 4. In Table 1, the multi-bit field “Index” corresponding to each combination of transmission and antenna configuration is jointly encoded. For example, for transmission mode “1”, the Index is a specific binary value “0000”. For transmission mode 2, the Index value “0001” corresponds to the antenna configuration 2, and the “0010” Index corresponds to the antenna configuration 4. Another exemplary four bit implementation is shown in Table 2 of FIG. 5. A Third embodiment allows the representation points to include the current transmission mode and antenna configuration as indicated in Table 3 illustrated in FIG. 6. Multi-user (MU) transmission refers to transmitting to two users at the same time on the same frequency band (or at least overlapping time-frequency resources) or more specifically the same set of subcarriers. Single Port 5 transmission refers to a transmission where transmitted symbols consist of both coded information symbols and UE-specific reference symbols. UE-specific reference symbols are symbols whose values are known to the UE and which are processed in an identical manner, e.g., in amplitude and phase when transmitting from multiple antennas, to coded information symbols. Rank 1 Closed Loop transmission refers to forming a transmitted signal at each transmission antenna from a sequence of coded symbols by multiplying with a complex-valued weight. The terms “open loop”, “transmission diversity”, and “closed loop” as used in this specification shall have the meanings defined by 3GPP 36.213v8.3, “Technical Specification Group Radio Access Network”, Evolved Universal Terrestrial Radio Access (E-TRA), Physical Layer Procedures.

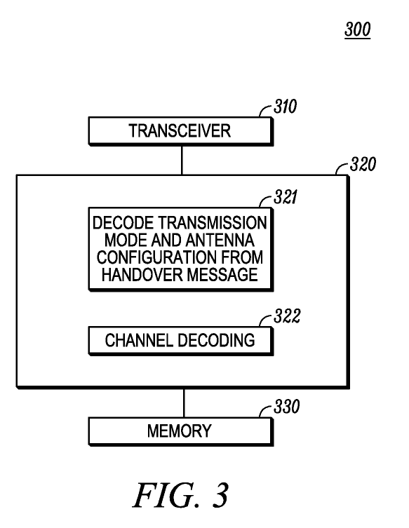

A wireless communication user terminal receiving the handover message decodes the transmission mode to be used after handover and the antenna configuration of a target cell from the message. In FIG. 3, the user terminal 300 includes a transceiver 310 communicably coupled to a controller 320, which is communicably coupled to memory 330 that stores code for configuring the controller to perform various functions. At 322, the controller includes functionality to decode channel coded messages received by the transceiver, and at 324 the controller includes functionality to decode the transmission and the antenna configuration jointly encoded in the messages received. Channel decoding generally occurs prior to decoding the transmission mode and antenna configuration information from the message. The controller is generally configured to decode transmission mode and antenna configuration information from a message received by the transceiver. As noted above, in one implementation, the transmission mode and antenna configuration information is jointly encoded in a multi-bit field value of the message wherein every bit state of the multi-bit value depends on both transmission mode and antenna configuration.

In alternative embodiments, in addition to transmission mode and antenna Configuration, it is also possible to jointly encode additional target cell configurations such as BCH timing, i.e., the alignment of the phase of the 40 ms BCH transmissions with the 10 ms radio frame, and/or the bandwidth of the target cell in the hand over message. It is useful for the UE to know the bandwidth of the target cell because the UE can configure its channel estimator to use received common reference signals over the entire band.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A wireless communication infrastructure entity, the entity comprising:
a transceiver;
a controller communicably coupled to the transceiver,
the controller configured to generate a message having a multi-bit field,
the controller configured to set a value of the multi-bit field,
the value of the multi-bit field jointly encoded over transmission mode and antenna configuration information,
transmission mode is specific to a link between a wireless communication infrastructure entity and a user terminal, and antenna configuration is specific to the wireless communication infrastructure entity.

2. The entity of claim 1, every bit state in the value of the multi-bit field depends on both transmission mode and antenna configuration.

3. The entity of claim 2, the transmission mode is specific to a link between the wireless communication infrastructure entity that generates the message and the user terminal, and the antenna configuration is specific to the wireless communication infrastructure entity that generates the message.

4. The entity of claim 2,
the message is a handover message,
the transmission mode is specific to a link between a target wireless communication infrastructure entity and the user terminal after handover, and the antenna configuration is specific to the target wireless communication infrastructure entity after handover.

5. The wireless entity of claim 4, the controller configured to set the value of the multi-bit field to indicate that the transmission mode to be used after handover and the antenna configuration of the target wireless communication infrastructure entity are the same as a transmission mode and an antenna configuration of a source wireless communication infrastructure entity.

6. The wireless entity of claim 2, the controller configured to set the value of the multi-bit field to indicate a default transmission mode and a default antenna configuration.

7. The wireless entity of claim 6,
the message is a handover message,
the controller configured to set the value of the multi-bit field to indicate that a transmission mode to be used after handover and an antenna configuration of a target wireless communication infrastructure entity are the same as a transmission mode and an antenna configuration of a source wireless communication infrastructure entity.

8. The wireless entity of claim 1, the controller configured to set the value of the multi-bit field to indicate a default transmission mode and an antenna configuration.

9. The wireless entity of claim 8, the default transmission mode is diversity transmission mode.

10. A wireless communication user terminal, the terminal comprising:
a transceiver;
a controller communicably coupled to the transceiver,
the controller configured to decode transmission mode and antenna configuration information from a message received by the transceiver,
the transmission mode and antenna configuration information is jointly encoded in a multi-bit field value of the message wherein every bit state of the multi-bit value depends on both transmission mode and antenna configuration,
transmission mode is specific to a link between the wireless communication user terminal and a wireless communication infrastructure entity, and antenna configuration is specific to the wireless communication infrastructure entity.

11. The terminal of claim 10, transmission mode is specific to a link between the wireless communication user terminal and a wireless communication infrastructure entity that generates the message, and the antenna configuration is specific to the wireless communication infrastructure entity that generates the message.

12. The terminal of claim 10,
the message is a handover message,
the transmission mode is specific to a link between a target wireless communication infrastructure entity and the wireless communication user terminal after handover, and the antenna configuration is specific to the target wireless communication infrastructure entity after handover.

13. The terminal of claim 12, the multi-bit field value indicates that the transmission mode to be used after handover and the antenna configuration of the target wireless communication infrastructure entity are the same as a transmission mode and an antenna configuration of a source wireless communication infrastructure entity.

14. The terminal of claim 12, the multi-bit field value indicates a default transmission mode and a default antenna configuration.

15. The terminal of claim 14,
the message is a handover message,
the multi-bit field value indicates that the transmission mode to be used after handover and the antenna configuration of the target wireless communication infrastructure entity are the same as a transmission mode and an antenna configuration of a source wireless communication infrastructure entity.

16. The terminal of claim 10, the multi-bit field value indicates a default transmission mode and an antenna configuration.

17. The terminal of claim 16, the default transmission mode is diversity transmission mode.
